(19) United States
(12) Patent Application Publication
(10) Pub. No.: US 2006/0061258 A1
(43) Pub. Date: Mar. 23, 2006

(54) Light emitting screen structure and image forming apparatus

(75) Inventors: Masahiro Tagawa, Kanagawa-Ken (JP); Osamu Takamatsu, Kanagawa-Ken (JP); Matsuya Hayashida, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/226,260

(22) Filed: Sep. 15, 2005

(30) Foreign Application Priority Data
Sep. 21, 2004 (JP) 2004-272794
Sep. 7, 2005 (JP) 2005-258742

(51) Int. Cl. H01J 1/62

(52) U.S. Cl. 313/496

(57) ABSTRACT

In an image forming apparatus in which a rear plate having electron-emitting devices and a face plate having light emitting members, a black matrix, and metal back electrodes are arranged so as to face each other, an influence on the electron-emitting devices by a discharge between the rear plate and the face plate is reduced, thereby realizing high durability and a long life. Strip shaped resistors which are parallel with the Y direction, phosphor, and a black matrix to shield an area between adjacent phosphor against the light are arranged to scanning wirings which are parallel with the X direction. Further, metal back electrodes which are electrically connected to the strip shaped resistors through the black matrix and cover the strip shaped resistors and phosphor are arranged in the X direction, thereby constructing the face plate.

### BACKGROUND OF THE INVENTION

1. Field of the Invention

The invention relates to a light emitting screen structure for forming an image by irradiation of an electron beam in a flat image forming apparatus using the electron beam such as a field emission display (FED) or the like and to an image forming apparatus using the light emitting screen structure.

2. Related Background Art

Hitherto, an image forming apparatus can be mentioned as a using form of electron-emitting devices. For example, there has been known a flat electron beam display panel in which an electron source substrate and a opposite substrate are arranged in parallel so as to face each other and which has been exhausted to a vacuum state, wherein a number of cold cathode electron-emitting devices are formed on the electron source substrate and the opposite substrate has phosphor and a metal back or a transparent electrode for accelerating electrons emitted from the electron-emitting devices. The flat electron beam display panel is preferable because a lighter weight and a larger display screen can be realized as compared with cathode ray tube (CRT) display apparatuses which are at present widely used. According to such a display panel, an image of higher luminance and higher quality can be provided as compared with other flat display panels such as flat display panel using liquid crystal, plasma display panel (PDP), electroluminescent (EL) display panel, and the like.

In the image forming apparatus of the type in which a voltage is applied between the opposite electrode such as metal back, transparent electrode, or the like and the electron-emitting device in order to accelerate the electron emitted from the cold cathode electron-emitting device as mentioned above, it is advantageous to apply a high voltage to obtain the maximum light emitting luminance. Since the emitted electron beam diverges until it reaches the opposite electrode in dependence on a kind of electron-emitting device, it is desirable that an inter-substrate distance between the electron source substrate and the opposite substrate is short in order to realize the display with high resolution.

However, if the inter-substrate distance becomes short, since an electric field between the substrates increases inevitably, there is a case where such a phenomenon that the electron-emitting device is broken by an unexpected discharge rarely occurs. In such a case, since a current is concentrated on a part of phosphor and flows therein, such a phenomenon that a part of a display screen shines or the like occurs.

To solve such a problem, it is necessary to reduce a frequency of the unexpected discharge or make it difficult to cause the discharge breakdown.

It is considered that the discharge breakdown of the electron-emitting device occurs by the following causes: a large current is concentrated on one point and flows therein for a short time, so that heat generation occurs; or a voltage applied to the electron-emitting device rises instantaneously and an overvoltage is applied thereto.

A method of serially inserting a limiting resistor as shown in FIG. 11 is considered as means for reducing the current which becomes the cause of the discharge breakdown (in the diagram, reference numeral 111 denotes a face plate as an anode and 112 indicates a rear plate having the electron-emitting device). However, for example, if the devices of the number (500 devices in the vertical direction×1000 devices in the lateral direction) are wired in a matrix shape and line-sequentially driven, about 1000 devices are simultaneously turned on, so that if such a method is used for those devices, the following problems occur.

Assuming that an emission current per device is equal to 5 μA in the case where about 1000 devices are simultaneously turned on in the state where a high voltage of 10 kV has been applied to the anode, an inflow current to the anode fluctuates in a range of 0 to 5 mA in dependence on an image pattern (light-on pattern). In the example in which a serial resistor of 1 MΩ is connected to the anode as shown in FIG. 11, a voltage drop in the serial resistor portion is equal to 0 to 5 kV and a luminance variation of about maximum 50% occurs.

Since the high voltage has been applied to the flat plates which face each other, an amount of charges which are accumulated in a capacitor reaches 10⁻⁶ coulomb when it is assumed that, for example, an area of each of the face plate 111 and the rear plate 112 in FIG. 11 is equal to 100 cm², an interval between them is equal to 1 mm, and a potential difference between both substrates is equal to 10 kV. This means that even if the charges are discharged for 1 μsec, the current of 1 A is concentrated on one point. Since the device breakdown is caused by such a discharge current, even if there is no problem of the foregoing luminance variation, the addition of the external serial resistor does not sufficiently solve the problem.

To solve those problems, the applicant of the present invention has proposed the method whereby an electrode to apply a voltage is divided in nonparallel with the direction of the scanning wirings and a resistor is arranged between the electrode and accelerating voltage applying means, thereby suppressing a discharge current generated between flat plates which face each other (refer to JP-A-10-326583 (EP866491A)). FIG. 12 shows such an example. FIG. 13 shows an equivalent circuit of FIG. 12. In the diagram, reference numeral 121 denotes divided electrodes (for example, ITO films). One side of each of the electrodes 121 is bound by a common electrode 125 through a resistor 122 (for example, NiO films). A high voltage can be applied to them from a terminal 123. Reference numeral 131 denotes a face plate and 132 indicates a rear plate.

By dividing the electrode of the face plate 131 and inserting a resistor R1 with a high resistance to each of the divided electrodes, a capacitance of a capacitor is reduced and a discharge current Ib2 is decreased. Thus, a fluctuation in the voltage applied to the device due to the discharge current Ib2 is decreased and a damage upon discharging is also improved.

However, a construction to further reduce the discharge current is demanded from such a viewpoint that it is desirable not to damage the electron-emitting device at the time of discharging.

### SUMMARY OF THE INVENTION

It is an object of the invention to provide a light emitting screen structure to further reduce a discharge current without deteriorating luminance. In an image forming apparatus using such a light emitting screen structure, it is another object of the invention to lighten an adverse influence on an electron-emitting device due to an unexpected discharge and to realize high durability and a long life.

According to the first invention of the present invention, there is provided a light emitting screen structure comprising:

a substrate;

a plurality of light emitting members locating on the substrate;

a plurality of metal backs which are divided along a first direction and a second direction which is not parallel to the first direction and each of the metal back covering at least one of the light emitting members; and

a plurality of strip shaped resistors which electrically connect at least a part of the plurality of metal backs and extend in the first direction,

wherein the strip shaped resistors are discontinuous at a gap portion between the metal backs in the second direction.

According to the second invention of the present invention, there is provided an image forming apparatus comprising:

an electron source having a plurality of electron-emitting devices, a plurality of signal wirings which are parallel with the first direction and electrically connect the electron-emitting devices among the plurality of electron-emitting devices, and a plurality of scanning wirings which are parallel with the second direction and electrically connect the electron-emitting devices among the plurality of electron-emitting devices; and

a light emitting screen structure in which light emission is performed by irradiation of electrons emitted from the electron-emitting devices,

wherein the light emitting screen structure is the light emitting screen structure according to the first invention of the present invention.

### BRIEF DESCRIPTION OF THE DRAWINGS

FIGS. 1A and 1B are schematic diagrams showing a construction of an embodiment of a light emitting material substrate of the invention;

FIG. 2 is a schematic diagram showing a construction of a display panel of an embodiment of an image forming apparatus of the invention;

FIG. 3 is a schematic diagram showing a construction of another embodiment of a light emitting material substrate of the invention;

FIGS. 4A, 4B, 4C, 4D, and 4E are schematic diagrams showing manufacturing steps of the light emitting material substrate of the embodiment of the invention;

FIGS. 5A and 5B are schematic diagrams showing a construction of another embodiment of the light emitting material substrate of the invention;

FIG. 6 is a schematic diagram showing another example of a metal back shape of the invention;

FIGS. 7A and 7B are schematic diagrams showing a construction of another embodiment of the light emitting material substrate of the invention;

FIG. 8 is a schematic diagram showing a construction of another embodiment of a light emitting substrate of the invention;

FIG. 9 is a schematic diagram showing a construction of another embodiment of an image forming apparatus of the invention;

FIG. 10 is a schematic plan view of a light emitting material substrate of the image forming apparatus of FIG. 9;

FIG. 11 is a schematic diagram showing a constructional example of a conventional image forming apparatus;

FIG. 12 is a schematic diagram showing a constructional example of a conventional light emitting material substrate;

FIG. 13 is an equivalent circuit diagram of the light emitting material substrate of FIG. 12;

FIG. 14 is an explanatory diagram of a resistance value of a resistor between adjacent metal back electrodes in the invention; and

FIG. 15 is an explanatory diagram of a resistance value of a resistor between adjacent metal back electrodes in a construction having a strip shaped electrode between the adjacent metal back electrodes.

### DETAILED DESCRIPTION OF THE PREFERRED EMBODIMENTS

In a light emitting material substrate of the invention, strip shaped resistors divided into a plurality of portions in the X direction are arranged so as to be discontinuous in an electrode gap between metal back electrodes divided into at least two or more portions in the X direction, preferably, they are arranged on the inside of the metal back electrodes. Owing to such a construction, a resistor between the metal back electrodes which are neighboring in the X direction is held in a high resistance state, thereby preventing an inflow of a discharge current between the metal back electrodes in the X direction. First, such a function will be described in comparison with a construction in which the strip shaped resistors are continuous in the gap between the adjacent metal back electrodes in the X direction.

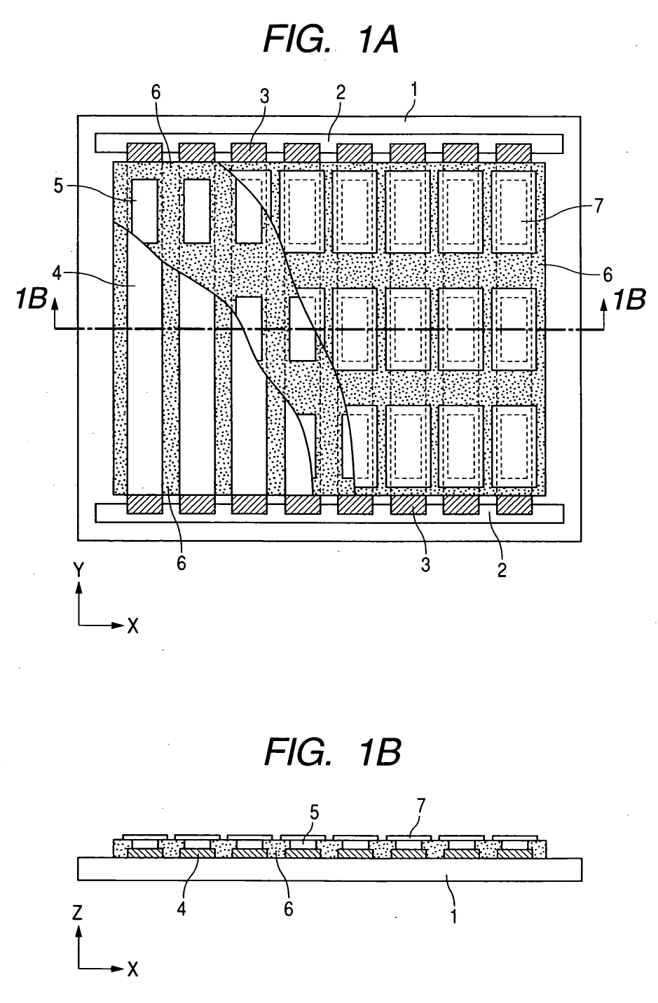

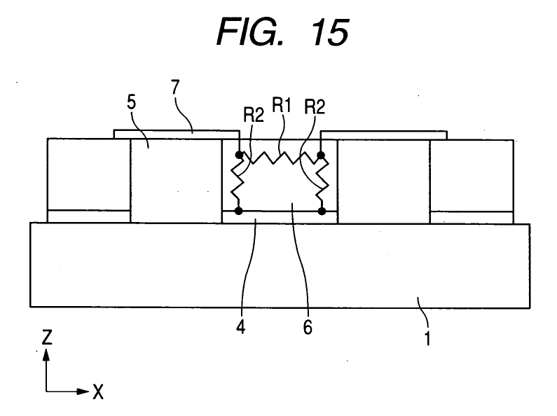

FIG. 14 is a partial cross sectional view in the direction which perpendicularly crosses a substrate in a preferred embodiment of the light emitting material substrate of the invention (corresponding to a cross sectional view taken along the line 1B-1B in FIG. 1A, which will be explained hereinafter). In the diagram, reference numeral 1 denotes a substrate; 4 a strip shaped resistor; 5 phosphor (light emitting member); 6 a black matrix (black member); and 7 a metal back electrode. The strip shaped resistor 4 is arranged in the metal back electrode 7. FIG. 15 is a partial cross sectional view of a construction in which the strip shaped resistors 4 are continuous in a gap between the metal back electrodes 7 in the X direction (the strip shaped resistor 4 rides over the gap between the metal back electrodes 7).

In the construction of FIGS. 14 and 15, assuming that a resistance value in the film thickness direction (Z direction) of the black matrix 6 is equal to R2, a resistance value in the film surface direction (X direction) is equal to R1, and a resistance of the strip shaped resistor 4 can be ignored, in the construction of FIG. 14, a resistor R between the metal back electrodes 7 in the X direction is equal to R1. On the other hand, in the construction of FIG. 15, a path which progresses in the film surface direction and a path which moves in the black matrix 6 in the film thickness direction and crosses the strip shaped resistor 4 exist as current paths between the adjacent metal back electrodes 7. Therefore, a synthesized resistance value R′ between the adjacent metal back electrodes 7 is as follows.

$$\begin{matrix}{R}^{′} = 1 / \{ ( 1 / R1 ) + ( 1 / 2 R2 ) \} \\ = ( R1 \cdot 2 R2 ) / ( 2 R2 + R1 )\end{matrix}$$

When comparing with R in FIG. 14,

$$R = \begin{matrix}R1 = R1 ( 2 R2 + R1 ) / ( 2 R2 + R1 ) \\ = \{ ( 2 R1 \cdot R2 ) + {( R1 )}^{2} \} / ( 2 R2 + R1 ) \\ = {R}^{′} + \{ {( R1 )}^{2} / ( 2 R2 + R1 ) \}\end{matrix}$$

That is, in the construction of FIG. 14 according to the invention, the resistance value between the metal back electrodes 7 is larger than that in the construction of FIG. 15 by an amount of (R1)²/(2R2+R1), so that the inflow of the discharge current can be reduced.

In the above description, the construction in which the strip shaped resistor 4 which is preferable as a light emitting material substrate of the invention is arranged on the inside of the metal back electrode 7 is shown. However, in the invention, the strip shaped resistor 4 can be also arranged in the gap between the metal back electrodes 7 so long as the current path which passes in the film thickness direction in the black matrix 6 and the strip shaped resistor 4 as shown in FIG. 15 is not formed. Specifically speaking, it is preferable to make the strip shaped resistors 4 discontinuous so that the resistance value in the film thickness direction of the black matrix and the strip shaped resistor 4 is larger than that of the through resistor in the film surface direction of the black matrix 6.

Since the distance between the adjacent metal back electrodes 7 in the Y direction (first direction) is larger than that in the X direction (second direction), even if the strip shaped resistor 4 is arranged between the adjacent metal back electrodes 7, the resistance can be increased and an influence which is exercised on the discharge current is small.

A fundamental construction of the light emitting material substrate (there is also a case where it is called a face plate) of the invention will be described hereinbelow with reference to FIGS. 1A and 1B.

FIGS. 1A and 1B are schematic diagrams showing a construction of the preferred embodiment of the light emitting material substrate of the invention. FIG. 1A is a plan view. FIG. 1B is a cross sectional view taken along the line 1B-1B in FIG. 1A. FIG. 1A shows the diagram with a part cut away in order to enable each positional relation to be easily understood. In FIGS. 1A and 1B, reference numeral 1 denotes the substrate made of a transparent insulating material such as glass or the like; 2 common electrodes; 3 serial resistors; 4 the strip shaped resistors divided into a plurality of portions in the X direction; and 5 phosphor (light emitting members). The strip shaped resistors 4 are arranged under phosphor 5. Further, the strip shaped resistors 4 are connected to the common electrodes 2 through the serial resistors 3. A high voltage is applied through a high voltage terminal (not shown). Reference numeral 6 denotes the black-matrix (black member) to shield an area between adjacent phosphor 5 against the light and 7 indicates the metal back electrodes 7 (hereinafter, simply referred to as metal backs). In the embodiment, the metal backs 7 are divided along the X and Y directions in correspondence to phosphor 5 (that is, every pixel) and arranged so as to be located on a front surface (on a rear plate side, which will be explained hereinafter) of phosphor 5.

In the invention, the strip shaped resistors 4 are preferably arranged on the inner side than the edges which are parallel with the Y direction of the metal back 7 so that they are not located between the metal backs which are neighboring in the X direction. It is desirable to arrange the strip shaped resistors 4 under phosphor 5. In addition, it is sufficient to use any type of strip shaped resistors 4 so long as it can control the resistance. Transparent electrodes can be used in the case where they are arranged under phosphor 5. In this case, ITO or the like can be used.

The metal back 7 is divided into at least two portions in the X directions and each metal back 7 is electrically connected to the strip shaped resistor 4 by the black matrix 6.

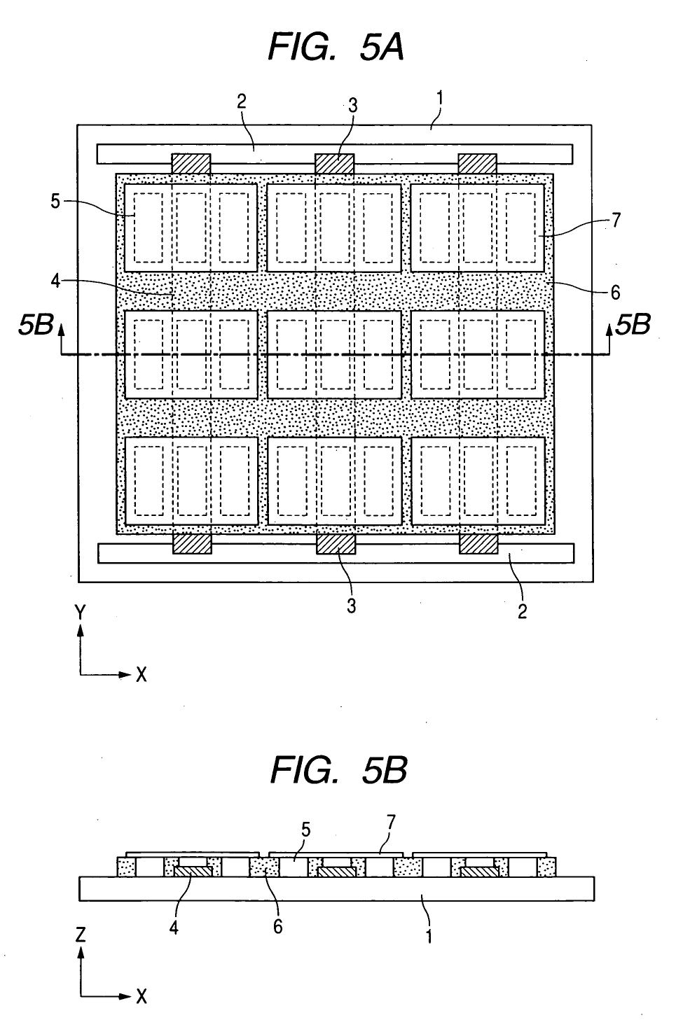

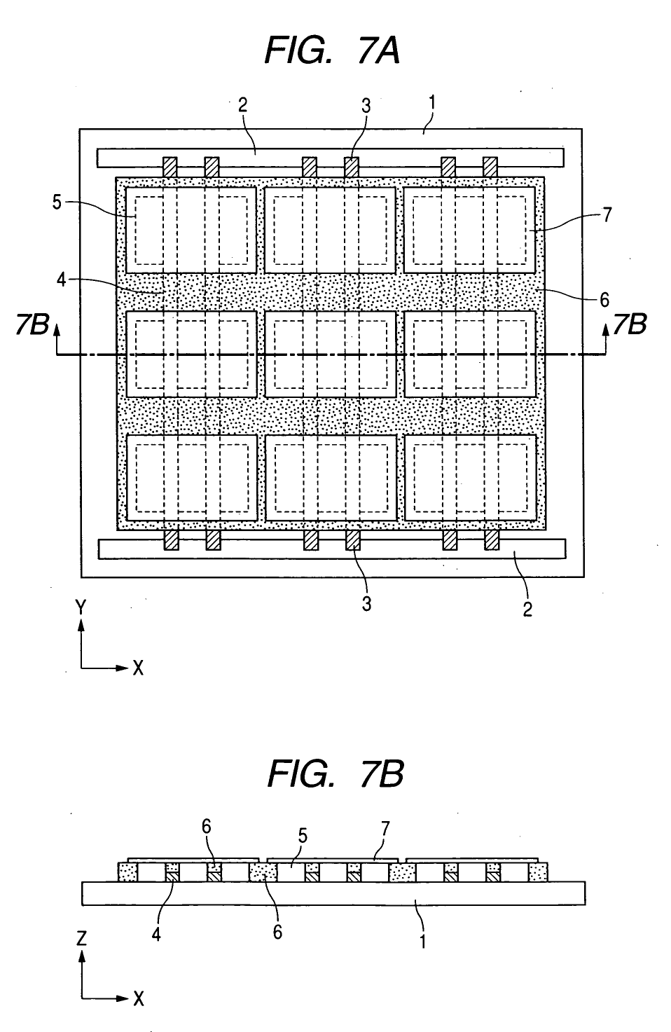

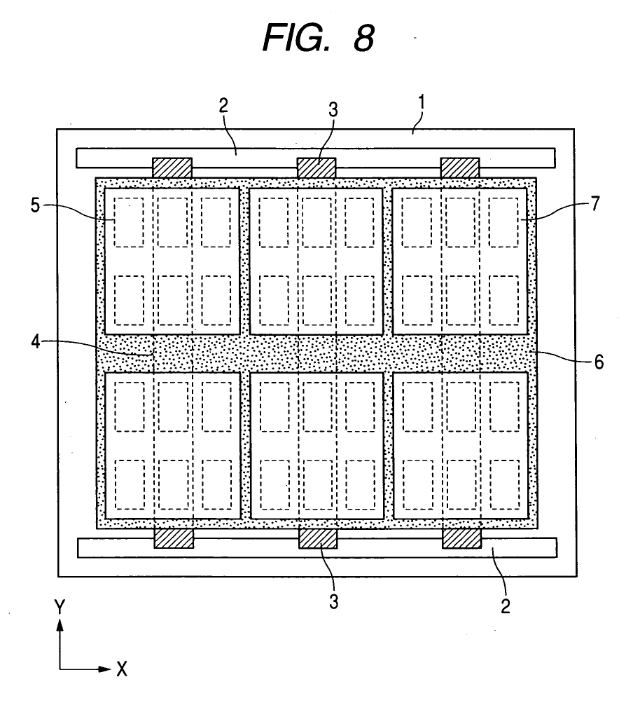

Since the resistance value of the strip shaped resistor 4 can be raised more in an allowable range of the voltage drop by dividing the metal back 7 on a phosphor unit basis as shown in FIGS. 1A and 1B, the discharge current can be reduced more and such a construction is preferable. However, a size of metal back is not limited to the size shown in the diagrams. For example, three phosphor units (for example, R, G, B) as shown in FIGS. 5A and 5B or FIGS. 7A and 7B or six pixel units as shown in FIG. 8 can be properly selected.

In the case of the strip shaped resistors 4 which are arranged in nonparallel with the scanning wirings which are parallel with the X direction, that is, which are arranged in parallel with the Y direction in the embodiment of FIGS. 1A and 1B, it is sufficient that their resistance values are set to about a value in which remarkable luminance deterioration due to the voltage drop does not occur when the image forming apparatus is driven. Specifically speaking, when the emission current of one electron-emitting device is equal to 1 to 10 μA, it is desirable that the resistance value of the strip shaped resistor is equal to 1 kΩ to 1 GΩ. The practical upper limit of the resistance value of the strip shaped resistor is determined to be a value in a range where the voltage drop is equal to or less than about 10 to tens of percentage of the applied voltage and no luminance fluctuation occurs.

Even when the discharge has occurred near the common electrode 2, the resistance value of the serial resistor 3 connecting the strip shaped resistor 4 and the common electrode 2 has to limit the discharge current flowing in the rear plate. Therefore, specifically speaking, it is desirable that the resistance value of the serial resistor 3 lies within a range of 10 kΩ to 1 GΩ, more preferably, 10 kΩ to 10 MΩ.

In the embodiment, the black matrix 6 electrically connects the strip shaped resistor 4 and the metal back 7. To limit the discharge current, it is desirable that the resistance value of the black matrix is set to 1 kΩ to 1 GΩ between the metal backs 7, more preferably, 1 kΩ to 1 MΩ. As a material of the black matrix 6, besides a material using graphite which is generally used as a main component, any material whose transmittance and reflectance of light are small can be used.

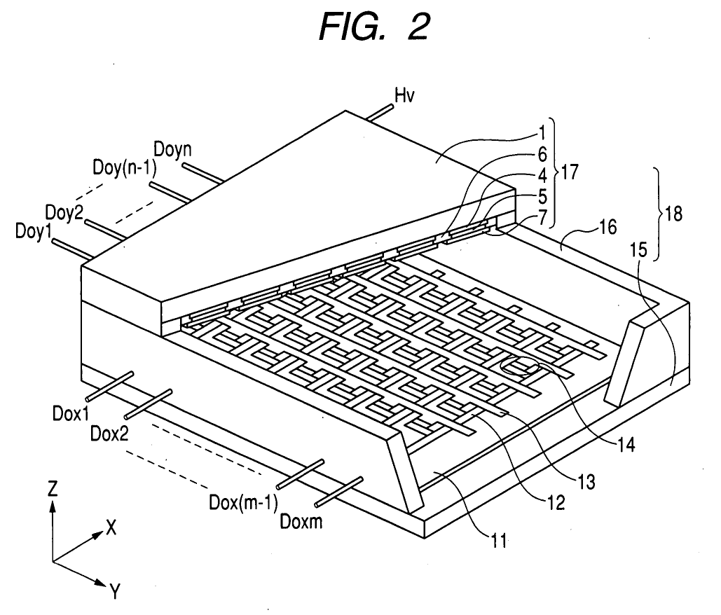

FIG. 2 shows a schematic constructional diagram of a display panel using the surface conduction electron-emitting devices as an example of the image forming apparatus using the light emitting material substrate of the invention. FIG. 2 illustrates the display panel with a part cut away. In the diagram, reference numeral 11 denotes an electron source substrate; 17 a face plate as an anode substrate; 16 an outer frame; and 15 a rear plate. A vacuum envelope 18 is constructed by those component elements. Reference numeral 14 denotes electron-emitting devices; 12 scanning wirings (scanning electrodes); and 13 signal wirings (signal electrodes). The scanning wirings 12 and the signal wirings 13 are connected to device electrodes of the electron-emitting devices 14. Component elements of the face plate 17 are designated by the same reference numerals as those shown in FIGS. 1A and 1B.

To form an image on the display panel, by sequentially applying a predetermined voltage to the scanning wirings 12 and the signal wirings 13 arranged in a matrix form, predetermined electron-emitting devices 14 locating at crossing points of the matrix are selectively driven. The electrons emitted by this method are irradiated to phosphor 5, thereby obtaining luminescent spots at predetermined positions. As for the metal back 7, to obtain the luminescent spots of higher luminance by accelerating the emission electrons, a high voltage Hv is applied to the electron-emitting devices 14 so as to have a high electric potential. The voltage which is applied here lies within a range about from hundreds of V to tens of kV although it depends on performance of phosphor 5. Therefore, generally, a distance between the rear plate 15 and the face plate 17 is set to a value in a range about from hundred μm to a few mm so that dielectric breakdown of the vacuum (that is, discharge) is not caused by the applied voltage.

In the case of a color phosphor film, phosphor 5 of each color of R (red), G (green), and B (blue) is used. As a method of coating the substrate 1 with phosphor 5, a settling method, a printing method, or the like can be used irrespective of a monochromatic display mode or a color display mode.

An object of the use of the metal back 7 is to improve the luminance by a method whereby the light to the inner surface side in the light emission of phosphor 5 is mirror-surface reflected to the substrate 1 side, to make the metal back function as an electrode for applying the accelerating voltage of the electron beam, to protect phosphor 5 from a damage that is caused by collision of negative ions generated in the vacuum envelope 18, or the like.

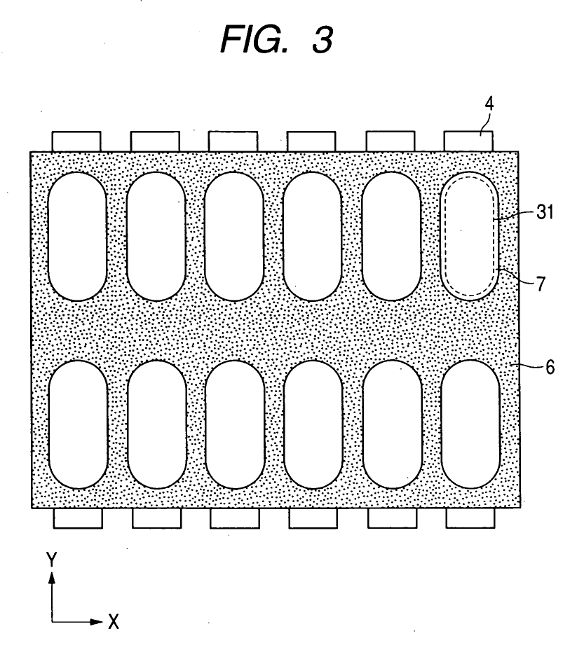

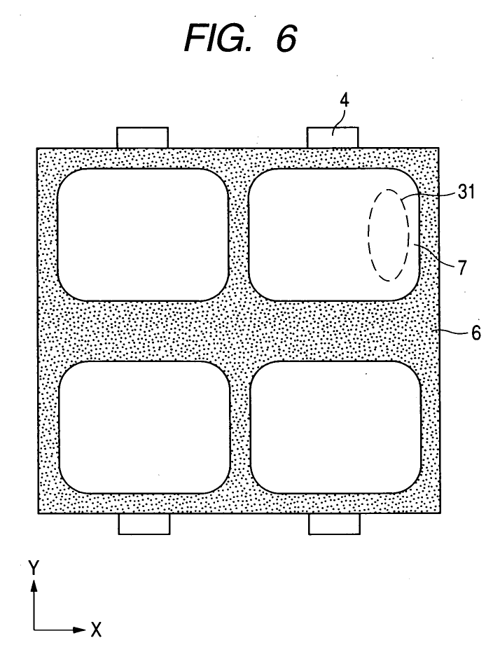

It is preferable to set a shape of the metal back 7 into a shape having a curved square corner. This is because when a discharge occurs between the face plate 17 and the rear plate 15, an electric potential difference occurs between the adjacent the metal backs 7, so that if the metal back does not have the curved corner, the electric field is concentrated and a creeping discharge occurs. Examples of the metal back having the curved corner are shown in FIGS. 3 and 6. In the diagram, reference numeral 31 denotes a shape of an electron beam. In the case where such a corner portion has a curvature, although it is desirable that a curvature of the curved corner is as large as possible in consideration of difficulty of occurrence of the discharge, it is necessary to set such a curvature in consideration of an irradiating area and a shape of the electron beam. In the surface conduction electron-emitting device (SCE) which is used in the invention, since the shape 31 of the electron beam which is irradiated is an arch shape, it is further preferable that such a curvature is close to the curvature corresponding to the 2-dimensional shape of the beam.

To form such divided metal backs 7, it is possible to use a method whereby the metal backs are formed on the whole surface of the substrate on which phosphor 5 has been formed by the ordinary method and the patterning is executed by a photo etching process. A method of evaporation-depositing by using a metal mask having a desired opening as a shielding member (ordinarily, such a method is called a mask evaporation deposition) or the like can be properly selected.

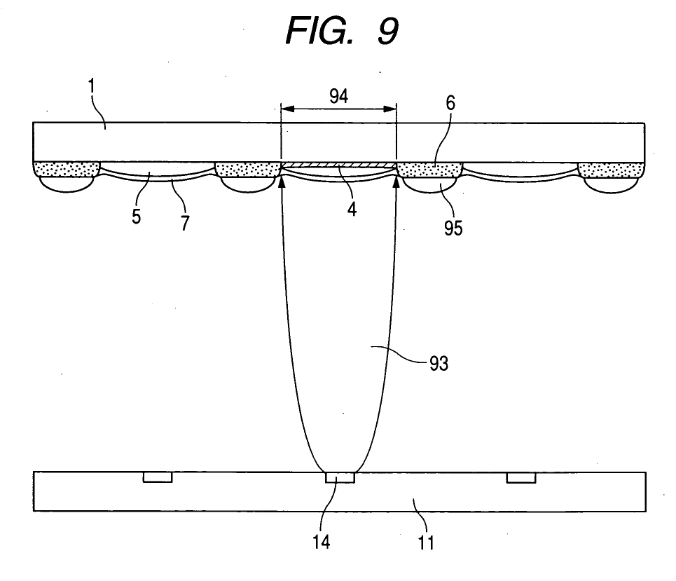

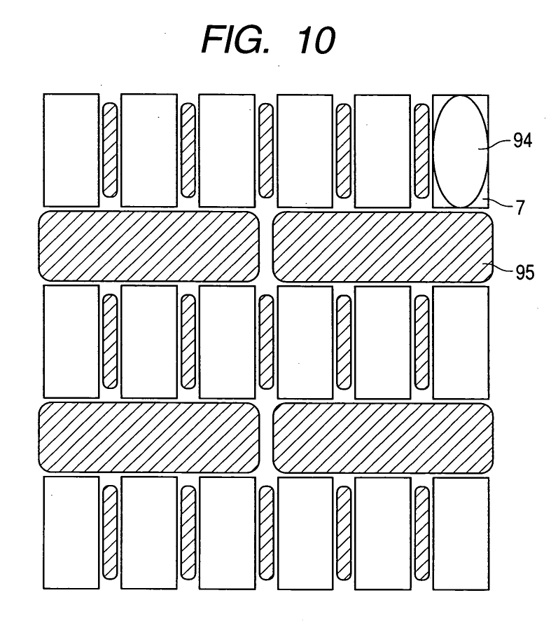

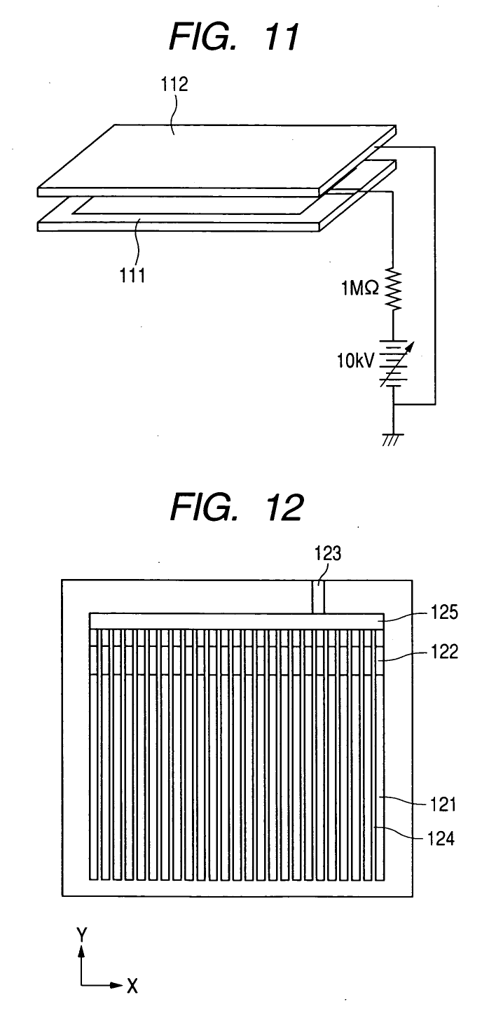

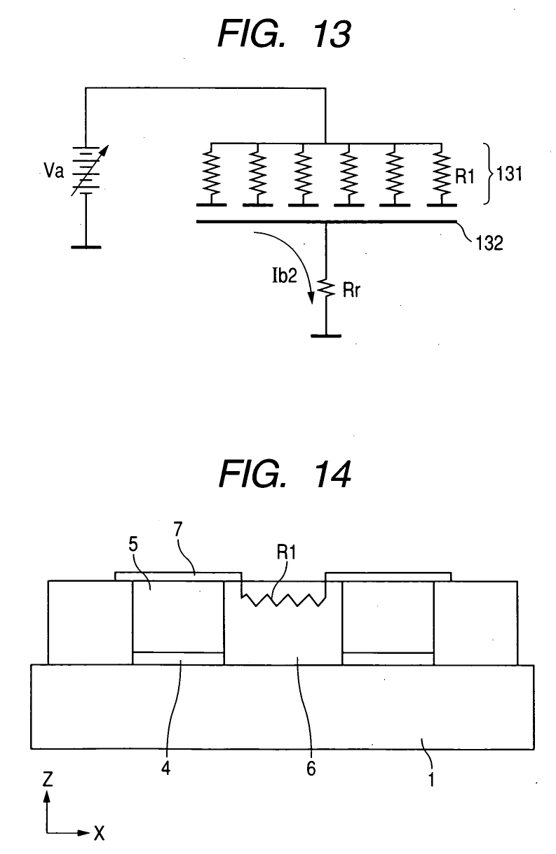

Further, in the case of manufacturing the image forming apparatus by using the light emitting substrate of the invention, a getter member can be also used to maintain the inside of the vacuum envelope 18 in a high vacuum state for a long period of time. In such a case, it is preferable to arrange the getter member to a region while avoiding the electron beam irradiating region where the electron beam emitted from the electron-emitting devices 14 is irradiated. This is because if the getter member is arranged in the electron irradiating region, an energy of the electron beam is decreased and desired luminance cannot be obtained. FIGS. 9 and 10 show schematic diagrams of a constructional example in which the getter member is arranged. In the diagrams, reference numeral 93 denotes an electron beam emitted from the electron-emitting device 14; 94 an irradiating range of the electron beam 93; and 95 a getter member. FIG. 9 is a partial cross sectional view. FIG. 10 is a plan view of the face plate 17 when seen from the rear plate side. It is desirable that a coated surface of the getter member is a coarse surface in order to increase an amount of getter member formed.

### Embodiment 1

The face plate with the construction shown in FIGS. 1A and 1B is formed. A manufacturing method will now be described.

A glass substrate (PD200 made by Asahi Glass Co., Ltd.) having a thickness of 2.8 mm is used as a substrate 1 and an ITO film having a thickness of 100 nm is formed on the whole surface. After that, the surface is patterned by a photolithography step so as to become a strip shape having a width of 185 μm, thereby forming the strip shaped resistors 4. A sheet resistance of the ITO film is adjusted to be 60 kΩ/□ so that the resistance value of the strip shaped resistor 4 is equal to about 200 MΩ.

Subsequently, NiO films which have been patterned as serial resistors 3 are formed on both sides of the strip shaped resistor 4. The common electrodes 2 are formed by using an Ag paste so as to be come into contact with all of the resistors 3. The resistance value of the serial resistor 3 is set to 10 MΩ.

The black matrix 6 (NP-7803D made by Noritake Co., Ltd.) is printed on the strip shaped resistor 4, thereby setting a value of the resistance (individual resistance) between the adjacent metal backs 7 to about 100 kΩ. Further, phosphor 5 is coated and baked.

Finally, an island-shaped Al film having a thickness of 80 nm is evaporation-deposited on phosphor 5, thereby forming the metal back 7. In this manner, a face plate having such a construction that the strip shaped resistors 4 are discontinuous between the metal backs which are neighboring in the X direction is formed.

The image forming apparatus shown in FIG. 2 is formed by using the face plate 17 manufactured as mentioned above. Specifically speaking, the electron source substrate 11 on which the scanning wirings 12, signal wirings 13, and electron-emitting devices 14 have been formed is arranged on the rear plate 15. The rear plate and the foregoing face plate are seal-bonded through the outer frame 16. Since the construction and forming method of the image forming apparatus are similar to those of the image forming apparatus disclosed in JP-A-10-326583 except for the face plate, its detailed explanation is omitted here.

With respect to the obtained image forming apparatus, discharge resisting tests are executed by deteriorating the vacuum degree in the panel. Thus, it has been confirmed that the currents flowing in the face plate 17 and the electron source substrate 11 at the time of the discharge are reduced more than those in the apparatus with the construction in which the metal backs 7 are not vertically and laterally divided. Further, no point defects occur in the discharging positions and the state before the discharge can be maintained.

Since the resistance value in the strip shaped resistor 4 can be set to a value in a voltage drop allowable range, the voltage drop in the strip shaped resistor upon driving the image forming apparatus is equal to or less than 250V and there is no problem in the luminance deterioration when it is confirmed by the eyes.

Although both ends of the strip shaped resistor 4 are connected to the common electrodes 2 through the serial resistors 3 in the embodiment, if the voltage drop upon driving lies within the allowable range, the common electrode 2 can be also provided only for one side.

### Embodiment 2

A light emitting substrate and, further, an image forming apparatus having constructions which are fundamentally similar to those in the embodiment 1 except that the pattern shape of the metal back 7 has a curved corner as shown in FIG. 3 are formed. The metal backs 7 are Al thin films divided by the mask evaporation deposition and their thicknesses are set to 100 nm. A size of metal back 7 is set to 600 μm×300 μm. A curvature of the corner is set to 50 μm as a radius in consideration of the electron beam shape 31.

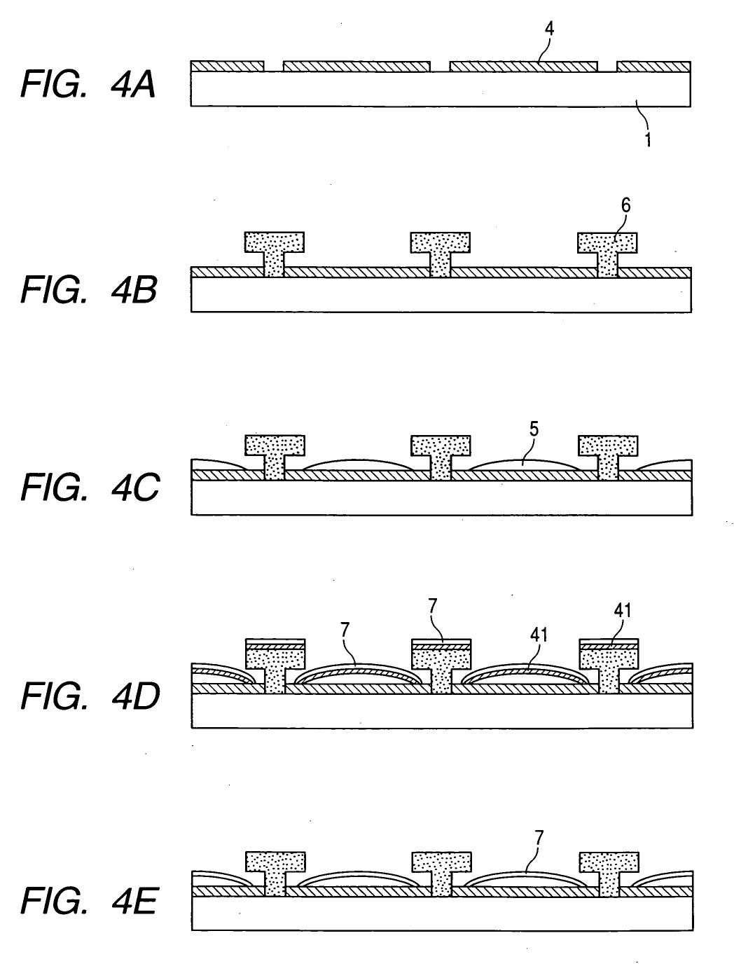

FIGS. 4A to 4E show manufacturing steps of the light emitting substrate of the embodiment.

First, an ITO film having a film thickness of 100 nm and a width of 200 μm is formed on the substrate 1 by using a sputtering method and the strip shaped resistor 4 is formed (FIG. 4A).

Subsequently, a photosensitive black matrix material is printed onto the whole surface of the substrate 1 by a screen printing and dried. Further, it is exposed by using a mask of a desired pattern and, after that, developed and baked, thereby forming the black matrix 6. At this time, by setting the developing time to be longer than the normal time, control is made so as to obtain a cross sectional shape having an under-cut shape as shown in FIGS. 4A to 4E. In general, the photosensitive black matrix is of a negative type and since it is inherently black, its photosensitivity is low. Even if an exposure amount is increased, it is difficult to be photo-sensed in the bottom portion. Therefore, such a shape can be relatively easily formed by controlling the exposure amount and the developing time (FIG. 4B).

Subsequently, phosphor 5 is formed in an opening portion of the black matrix 6 by printing and baking. At this time, phosphor 5 is formed so as not to be come into contact with an overhang portion of the black matrix 6. This is because in the Al evaporation deposition in the post-step, it is necessary to cause a step cutting of Al between the black matrix portion and the opening portion of the black matrix (FIG. 4C).

Subsequently, a filming material (binding agent and acrylic emulsion) 41 is spray-coated onto a display screen region and dried. After that, an Al film having a thickness of 100 nm is formed as a metal back 7 onto the display screen region by a vacuum evaporation depositing method. At this time, the Al films on phosphor 5 and the black matrix 6 are the separated films in which the step cutting has occurred (FIG. 4D).

Subsequently, the filming material 41 is baked at 450° C. for 60 minutes, thereby obtaining the face plate. At this time, since adhesion of the Al film on the black matrix 6 is low, the whole Al film is peeled off from the black matrix 6 upon baking. Since the metal backs 7 manufactured as mentioned above can be divided in a self alignment manner and, further, the Al portion on the black matrix 6 can be removed, the reduction in capacitance and the improvement of the withstanding voltage between the metal backs 7 can be certainly realized.

The image forming apparatus shown in FIG. 2 is manufactured in a manner similar to the embodiment 1 by using the face plate formed as mentioned above. The durability tests of 5000 hours are executed to this image forming apparatus while displaying various images in a manner similar to the embodiment 1. Thus, although the discharge occurs twice, a damage due to the creeping discharge between the adjacent metal backs 7 does not occur and the stable and good image is held. Consequently, it is shown that the image forming apparatus of the invention is effective for improvement of the withstanding voltage between the adjacent metal backs.

### Embodiment 3

As a third embodiment of the invention, the face plate with a construction shown in FIGS. 5A and 5B is manufactured by a manufacturing method similar to that in the embodiment 1. The embodiment differs from the embodiment 1 with respect to a point that the face plate is formed in such a manner that three pixels of phosphor (R, G, B) are covered as one unit by one metal back 7 and a point that one strip shaped resistor 4 is arranged for one metal back 7.

In the embodiment, a glass substrate (PD200 made by Asahi Glass Co., Ltd.) having a thickness of 2.8 mm is used as a substrate 1 and an ITO film having a width of 185 μm and a thickness of 100 nm is used as a strip shaped resistor 4. A sheet resistance of the ITO film is adjusted to be 20 kΩ/□ so that the resistance value is equal to about 70 MΩ. Further, a sheet resistance of the black matrix 6 is adjusted to be 2 MΩ/□ so that a value of the resistance (individual resistance) between the adjacent metal backs 7 is equal to about 200 kΩ. A resistance value of the serial resistor 3 is set to 10 MΩ. As shown in FIGS. 5A and 5B, the strip shaped resistors 4 are arranged so as not to be located over the metal backs 7 which are neighboring in the X direction.

The image forming apparatus shown in FIG. 2 is formed in a manner similar to the embodiment 1 by using the obtained face plate. The durability tests of this image forming apparatus are executed while deteriorating a vacuum degree in the panel. Thus, it has been confirmed that the currents flowing in the face plate 17 and the rear plate 15 upon discharging has been reduced as compared with those of the apparatus having such a construction that the metal backs 7 are not vertically and laterally divided. Further, no point defects occur in the discharging positions and the state before the discharge can be maintained.

Since the resistance value in the strip shaped resistor 4 can be set to a value in the voltage drop allowable range, the voltage drop (due to the resistor in the electrode) in the strip shaped resistor upon driving the image forming apparatus is equal to or less than 275V and there is no problem in the luminance deterioration when it is confirmed by the eyes.

Although both ends of the strip shaped resistor 4 are connected to the common electrodes 2 through the serial resistors 3 in the embodiment, if the voltage drop upon driving lies within the allowable range, the common electrode 2 can be also provided only for one side.

Although one strip shaped resistor 4 is arranged for one metal back 7 in the embodiment, the invention is not limited to such a construction but one strip shaped resistor 4 can be also arranged for one phosphor 5. At this time, since a plurality of strip shaped resistors 4 are connected in parallel in one metal back, it is preferable to raise the resistance value of each strip shaped resistor.

Further, it is also possible to allow the metal back to have a curved corner as shown in FIG. 6 in order to prevent that the electric field is concentrated on the corner of the metal back 7 and the creeping discharge is caused.

### Embodiment 4

As a fourth embodiment of the invention, the face plate with a construction shown in FIGS. 7A and 7B is manufactured in a manner similar to that in the embodiment 1. The embodiment differs from the embodiment 3 with respect to a point that the strip shaped resistor 4 is arranged under the black matrix 6.

In the embodiment, a glass substrate (PD200 made by Asahi Glass Co., Ltd.) having a thickness of 2.8 mm is used as a substrate 1. An ITO film in which a width is equal to 40 μm and a sheet resistance is adjusted to be 100 kΩ/□ so that the resistance value is equal to about 150 MΩ is used as a strip shaped resistor 4. Further, a sheet resistance of the black matrix 6 is adjusted to be 2 MΩ/□ so that a value of the resistance (individual resistance) between the metal backs 7 is equal to about 200 kΩ. A resistance value of the serial resistor 3 is set to 10 MΩ. Also in the embodiment, as shown in FIGS. 7A and 7B, the strip shaped resistors 4 are arranged so as not to be located over the metal backs 7 which are neighboring in the X direction.

The image forming apparatus shown in FIG. 2 is formed in a manner similar to the embodiment 1 by using the obtained face plate. The discharge resisting tests are executed to this image forming apparatus while deteriorating a vacuum degree in the panel. According to such a construction, in a manner similar to each of the foregoing embodiments, it has been also confirmed that the currents flowing in the face plate 17 and the rear plate 15 upon discharging has been reduced as compared with those of the apparatus having such a construction that the metal backs 7 are not vertically and laterally divided. Further, no point defects occur in the discharging positions and the state before the discharge can be maintained.

Since the resistance value in the strip shaped resistor 4 can be set to a value in the voltage drop allowable range, the voltage drop in the strip shaped resistor upon driving the image forming apparatus is equal to or less than 275V and there is no problem in the luminance deterioration when it is confirmed by the eyes.

### Embodiment 5

As a fifth embodiment of the invention, the face plate with a construction shown in FIG. 8 is manufactured in a manner similar to that in the embodiment 1. The embodiment differs from the embodiments 1 and 3 with respect to a point that six pixels of phosphor 5 are formed as one unit so as to be covered by one metal back 7.

In the embodiment, a glass substrate (PD200 made by Asahi Glass Co., Ltd.) having a thickness of 2.8 mm is used as a substrate 1. An ITO film in which a width is equal to 140 μm and a sheet resistance is adjusted to be 15 kΩ/□ so that the resistance value is equal to about 50 MΩ is used as a strip shaped resistor 4. Further, a sheet resistance of the black matrix 6 is adjusted to be 1 MΩ/□ so that a value of the resistance (individual resistance) between the metal backs 7 is equal to about 200 kΩ. A resistance value of the serial resistor 3 is set to 1 MΩ.

The image forming apparatus shown in FIG. 2 is formed in a manner similar to the embodiment 1 by using the obtained face plate. The discharge resisting tests are executed to this image forming apparatus while deteriorating a vacuum degree in the panel. According to the embodiment, in a manner similar to each of the foregoing embodiments, it has been also confirmed that the currents flowing in the face plate 17 and the rear plate 15 upon discharging has been reduced as compared with those of the apparatus having such a construction that the metal backs 7 are not vertically and laterally divided. Further, no point defects occur in the discharging positions and the state before the discharge can be maintained.

Since the resistance value in the strip shaped resistor 4 can be set to a value in the voltage drop allowable range, the voltage drop in the strip shaped resistor upon driving the image forming apparatus is equal to or less than 275V and there is no problem in the luminance deterioration when it is confirmed by the eyes.

### Embodiment 6

As a sixth embodiment of the invention, the image forming apparatus shown in FIGS. 9 and 10 is manufactured.

According to the image forming apparatus in the embodiment, the electron beam 93 emitted from the electron-emitting device 14 is accelerated by the metal back 7, enters phosphor 5, and light is emitted.

The face plate in the embodiment is manufactured by a method similar to that in the embodiment 1 with respect to the manufacturing steps which are executed until the metal backs 7 are formed. After that, as shown in FIG. 10, a Ti thin film having a thickness of 500 nm is formed on the black matrix 6 having the coarse surface by a mask evaporation depositing method. Further, Ti is activated simultaneously with the baking of the substrate just before the seal-bonding, thereby forming the getter member 95.

The image forming apparatus shown in FIG. 2 is manufactured in a manner similar to the embodiment 1 by using the obtained face plate. The durability tests of 5000 hours are executed to this image forming apparatus while displaying various images in a manner similar to the embodiment 1. Thus, although the discharge occurs twice, damages of the metal backs 7 and the Ti thin film are not caused and the stable and good image is held.

According to the invention, since the strip shaped resistors divided in nonparallel with the scanning wirings are used, the voltage drop upon driving is reduced. Further, in the X direction (the second direction, preferably, the direction of the scanning wirings), the strip shaped resistors are discontinuous in the gap between the adjacent metal backs. Thus, even if the value of the resistance between the metal back electrodes is large and the unexpected discharge occurs between the light emitting material substrate (light emitting screen structure) and the electron source substrate, the damage of the electron-emitting devices due to such a discharge is small. According to the invention, therefore, the damage of the electron-emitting devices due to the discharge is lightened and the image forming apparatus in which the high durability, the long life, and the high reliability are obtained is provided.

This application claims priorities from Japanese Patent Application Nos. 2004-272794 filed on Sep. 21, 2004, and 2005-258742 filed on Sep. 7, 2005, which are hereby incorporated by reference herein.

What is claimed is:

1. A light emitting screen structure comprising:
a substrate;
a plurality of light emitting members locating on said substrate;
a plurality of metal backs which are divided along first direction and a second direction which is not parallel to said first direction, and each of the metal backs covering at least one of said light emitting members; and
a plurality of strip shaped resistors which electrically connect at least a part of said plurality of metal backs and extend in said first direction,
wherein said strip shaped resistors are discontinuous at a gap portion between the metal backs in said second direction.

2. A structure according to claim 1, wherein said strip shaped resistors are located in a metal back forming region in said second direction.

3. A structure according to claim 1, wherein said strip shaped resistor is made of a transparent member.

4. A structure according to claim 1, wherein getter members are arranged among said plurality of metal backs.

5. A structure according to claim 1, wherein said metal back has a shape having a curved square corner.

6. An image forming apparatus comprising:
an electron source having a plurality of electron-emitting devices, a plurality of signal wirings which are parallel with said first direction and electrically connect at least a part of said plurality of electron-emitting devices, and a plurality of scanning wirings which are parallel to said second direction and electrically connect at least a part of said plurality of electron-emitting devices; and
a light emitting screen structure in which light emission is performed by irradiation of electrons emitted from said electron-emitting devices,
wherein said light emitting screen structure is the light emitting screen structure according to claim 1.
